(19) United States
(12) Patent Application Publication
(10) Pub. No.: US 2014/0264994 A1
(43) Pub. Date: Sep. 18, 2014

(54) Process of Forming a Personal Care Article

(71) Applicant: The Procter & Gamble Company, Cincinnati, OH (US)

(72) Inventors: Robert Wayne GLENN, JR., Liberty Twp, OH (US); Todd Ryan THOMPSON, Loveland, OH (US); Ungyeong JUNG, North Royalton, OH (US); Chul B. PARK, Etobicoke (CA); Changwei ZHU, Richmond Hill (CA)

(73) Assignee: The Procter & Gamble Company, Cincinnati, OH (US)

(21) Appl. No.: 14/211,503

(22) Filed: Mar. 14, 2014

Related U.S. Application Data
(60) Provisional application No. 61/794,582, filed on Mar. 15, 2013.

(51) Int. Cl. B29C 44/02

(52) U.S. Cl. CPC B29C 44/02
USPC 264/53

(57) ABSTRACT

Provided is a process for forming a personal care article comprising producing a personal care article from a twin screw extruder employing blowing agents, the personal care article including (i) from about 10% to about 60% of one or more anionic surfactants, wherein the one or more anionic surfactants have a Krafft point of less than about 30° C.; (ii) from about 10% to about 50% of one or more water soluble polymers; (iii) from about 1% to about 30% of one or more plasticizers; and (iv) from about 0.01% to about 40% water. The personal care article has a density of from about 0.05 g/cm³ to about 0.95 g/cm³.

### FIELD OF THE INVENTION

The present invention relates to a process of forming a personal care article comprising a surfactant, a water soluble polymer, a plasticizer, and water.

### BACKGROUND OF THE INVENTION

Solid soaps are generally harsh and lead to a squeaky feel on the skin and hair. These qualities are generally unacceptable for many of today's consumers.

Anionic surfactants such as alkyl ether sulfates have been developed to improve upon the disadvantages of solid soaps. However, many anionic surfactants have low Krafft points and are thereby generally formulated only in liquid products. This is one of the primary reasons for the proliferation of liquid shampoos and liquid body washes across the personal care industry. While widely used, liquid products have disadvantages in terms of packaging, storage, transportation, and convenience of use.

To address the disadvantages of liquid products, attempts have been made to incorporate the benefits of low Krafft point anionic surfactants into dissolvable solids. One attempt was to structure the dissolvable solid with one or more water soluble polymers via a casting and drying process. However, this process was energy intensive and costly because it involves the drying of significant amounts of water (typically >50%).

Another attempt was to create porous solids comprising low Krafft point anionic surfactants by freeze-drying. However, freeze-drying was also an energy intensive and costly process.

Producing a personal care article via extrusion is a challenge due to the hydrolytic degradation of low Krafft point anionic surfactants under high temperature extrusion conditions. Additionally, low Krafft point anionic surfactants are typically available as aqueous “lamellar” pastes (comprising >30% water) and impart significant lubricity inside the extruder barrel which significantly limits the friction and torque between the mixing elements and the extruder barrel, inhibiting the ability of the extruder to work effectively. Moreover, the large viscosity difference between low Krafft point anionic surfactants (as available commercially) and water soluble polymers imposes significant mixing challenges.

Based on the forgoing, there is a need for producing a lower cost personal care article by extrusion foaming comprising one or more anionic surfactants and a water soluble polymer.

### SUMMARY OF THE INVENTION

According to an embodiment of the invention, there is provided a process for forming a personal care article comprising (a) producing an extrudate from a twin screw extruder; and (b) extrusion foaming the extrudate into the personal care article, the personal care article comprising (i) from about 10% to about 60% of one or more anionic surfactants, wherein the one or more anionic surfactants have a Krafft point of less than about 30° C.; (ii) from about 10% to about 50% of one or more water soluble polymers; (iii) from about 1% to about 30% of one or more plasticizers; and (iv) from about 0.01% to about 40% water; wherein the personal care article has a density of from about 0.05 g/cm³ to about 0.95 g/cm³.

According to another embodiment of the invention, there is provided a process of forming a personal care composition comprising (a) adding one or more water soluble polymers and one or more plasticizers to a twin screw extruder at from about 150° C. to about 400° C. to form a premix; (b) cooling the premix to from about 100° C. to about 135° C. while mixing one or more anionic surfactants and water with the premix to form a mixture; and (c) incorporating a blowing agent into the extrusion barrel to form a personal care composition comprising; (i) from about 10% to about 60% of one or more anionic surfactants, wherein the one or more anionic surfactants have a Krafft point of less than about 30° C.; (ii) from about 10% to about 50% of one or more water soluble polymers; (iii) from about 1% to about 30% of one or more plasticizers; and (iv) from about 0.01% to about 40% water; wherein the personal care article has a density of from about 0.05 g/cm³ to about 0.95 g/cm³.

These and other features, aspects, and advantages of the invention will become evident to those skilled in the art from a reading of the following disclosure.

### DETAILED DESCRIPTION OF THE INVENTION

While the specification concludes with claims which particularly point out and distinctly claim the invention, it is believed the present invention will be better understood from the following description.

In all embodiments of the present invention, all percentages are by weight of the total composition, unless specifically stated otherwise. All ratios are weight ratios, unless specifically stated otherwise. The number of significant digits conveys neither a limitation on the indicated amounts nor on the accuracy of the measurements. All numerical amounts are understood to be modified by the word “about” unless otherwise specifically indicated. Unless otherwise indicated, all measurements are understood to be made at 25° C. and at ambient conditions, where “ambient conditions” means conditions under about one atmosphere of pressure and at about 50% relative humidity. All such weights as they pertain to listed ingredients are based on the active level and do not include carriers or by-products that may be included in commercially available materials, unless otherwise specified.

The term “comprising,” as used herein, means that other steps and other ingredients which do not affect the end result can be added. This term encompasses the terms “consisting of” and “consisting essentially of.” The compositions and methods/processes of the present invention can comprise, consist of, and consist essentially of the elements and limitations of the invention described herein, as well as any of the additional or optional ingredients, components, steps, or limitations described herein.

The term “extruded,” as used herein, means having been produced from the basic components of an extrusion line including a polymer feed, the extruder drive and gear box, the extruder barrel with one or two screws, one or more other injection ports, and the extrusion die. The extruder drive may be electrical in operation and may be geared via a thrust bearing to produce the rotational movement of the one or two extruder screws. The polymer feed to the screw may be from the feed hopper and the feed may be by gravity, metering screw, or simple conveying spiral. The extruder barrel and one or two extruder screws are of high strength steels and are protected from wear and corrosion by a variety of hardening and coating treatments such as nitriding and hard chroming. The extrusion barrel and screw are zoned into between 3 and 15 sections which are individually heated and cooled depending on the material and process parameters. The extrusion die channels the polymer melt from the front of the one or two extruder screws to form the basic shape of the desired product.

The term “Krafft point,” as used herein, (also known as Krafft temperature, or critical micelle temperature) means the minimum temperature at which surfactants form micelles. Below the Krafft point, there is no value for the critical micelle concentration (CMC), i.e., micelles cannot form. The Krafft point is a point of phase change below which the surfactant remains in crystalline form, even in aqueous solution. The Krafft point is measured experimentally as the temperature (more precisely, narrow temperature range) above which the solubility of a surfactant rises sharply. At this temperature, the solubility of the surfactant becomes equal to the critical micelle concentration. The Krafft point of a surfactant is best determined by locating the abrupt change in slope of a graph of the logarithm of the surfactant's solubility versus temperature [Source: PAC, 1972, 31, 577 (Manual of Symbols and Terminology for Physicochemical Quantities and Units, Appendix II: Definitions, Terminology and Symbols in Colloid and Surface Chemistry) on page 613].

The term “plasticizer,” as used herein, means any of various substances (typically a solvent) added to a polymer composition to reduce brittleness and to promote plasticity and flexibility.

The term “semi-solid,” as used herein, means a state of matter which is highly viscous and has the qualities of both a solid and a liquid.

The term “solid,” as used herein, means a state of matter wherein the constituents are arranged such that their shape and volume are relatively stable, i.e., not liquid-like or gaseous.

The term “water soluble polymer,” as used herein, includes both water-soluble and water-dispersible polymers, and is defined as a polymer with a solubility in water, measured at 25° C., of at least about 0.1 gram/liter (g/L).

Provided is a process for forming a personal care article comprising (a) producing an extrudate from a twin screw extruder; and (b) extrusion foaming the extrudate into the personal care article, the personal care article comprising (i) from about 10% to about 60% of one or more anionic surfactants, wherein the one or more anionic surfactants have a Krafft point of less than about 30° C.; (ii) from about 10% to about 50% of one or more water soluble polymers; (iii) from about 1% to about 30% of one or more plasticizers; and (iv) from about 0.01% to about 40% water; wherein the personal care article has a density of from about 0.05 g/cm³ to about 0.95 g/cm³.

The personal care article may have an density of from about 0.05 g/cm³ to about 0.95 g/cm³, alternatively from about 0.10 g/cm³ to about 0.90 g/cm³, alternatively from about 0.15 g/cm³ to about 0.85 g/cm³, alternatively from about 0.20 g/cm³ to about 0.80 g/cm³, and alternatively from about 0.25 g/cm³ to about 0.75 g/cm³.

The density of the personal care article may be determined by the equation: Calculated Density=Basis Weight of porous solid/(Porous Solid Thickness×1,000). The Basis Weight and Thickness of the personal care article are determined in accordance with the methodologies described herein.

The Basis Weight of the personal care article component of the personal care composition herein is calculated as the weight of the personal care article component per area of the selected personal care article (grams/m²). The area is calculated as the projected area onto a flat surface perpendicular to the outer edges of the personal care article. For a flat object, the area is thus computed based on the area enclosed within the outer perimeter of the sample. For a spherical object, the area is thus computed based on the average diameter as 3.14×(diameter/2)². For a cylindrical object, the area is thus computed based on the average diameter and average length as diameter×length. For an irregularly shaped three dimensional object, the area is computed based on the side with the largest outer dimensions projected onto a flat surface oriented perpendicularly to this side. This can be accomplished by carefully tracing the outer dimensions of the object onto a piece of graph paper with a pencil and then computing the area by approximate counting of the squares and multiplying by the known area of the squares or by taking a picture of the traced area (shaded-in for contrast) including a scale and using image analysis techniques.

The thickness of the personal care article (i.e., substrate or sample substrate) may be obtained using a micrometer or thickness gage, such as the Mitutoyo Corporation Digital Disk Stand Micrometer Model Number IDS-1012E (Mitutoyo Corporation, 965 Corporate Blvd, Aurora, Ill., USA 60504). The micrometer has a 1 inch diameter platen weighing about 32 grams, which measures thickness at an application pressure of about 0.09 psi (6.32 gm/cm²).

The thickness of the personal care article may be measured by raising the platen, placing a section of the sample substrate on the stand beneath the platen, carefully lowering the platen to contact the sample substrate, releasing the platen, and measuring the thickness of the sample substrate in millimeters on the digital readout. The sample substrate should be fully extended to all edges of the platen to make sure thickness is measured at the lowest possible surface pressure, except for the case of more rigid substrates which are not flat. For more rigid substrates which are not completely flat, a flat edge of the substrate is measured using only one portion of the platen impinging on the flat portion of the substrate.

For spherical, or cylindrical personal care article extrudates, the density can be measured by measuring weight and dividing by the measured volume. The volume can be measured based on the diameter (employing micrometer approached cited above) for spheres and the corresponding length (for cylinders).

For irregularly shaped personal care articles (non-rectangular, non-square, non-spherical, non-cylindrical) an immersion density method can be employed to measure the density as taught in US20030186826.

The personal care article may have a dry density of from about 0.02 g/cm³ to about 0.30 g/cm³, alternatively from about 0.06 g/cm³ to about 0.20 g/cm³, and alternatively from about 0.08 g/cm³ to about 0.15 g/cm³.

### Anionic Surfactant

The personal care article may comprise from about 10% to about 60%, alternatively from about 12% to about 50%, and alternatively from about 15% to about 40% of one or more anionic surfactants, by weight of the personal care article. The one or more anionic surfactants may have a Krafft point of less than 30° C., alternatively less than 25° C., alternatively less than 20° C., alternatively less than 15° C., and alternatively less than 10° C.

Non-limiting examples of anionic surfactants may be selected from the group consisting of alkyl sulfates, alkyl ether sulfates, branched alkyl sulfates, branched alkyl alkoxylates, branched alkyl alkoxylate sulfates, alkyloxy alkane sulfonates mid-chain branched alkyl aryl sulfonates, sulfated monoglycerides, sulfonated olefins, alkyl aryl sulfonates, primary or secondary alkane sulfonates, alkyl sulfosuccinates, acyl taurates, acyl isethionates, alkyl glycerylether sulfonate, sulfonated methyl esters, sulfonated fatty acids, alkyl phosphates, acyl glutamates, acyl sarcosinates, alkyl sulfoacetates, acylated peptides, alkyl ether carboxylates, acyl lactylates, anionic fluorosurfactants, sodium lauroyl glutamate, and combinations thereof.

In an embodiment, the one or more anionic surfactants may comprise one or more alkyl ether sulfates according to the following structure:

[chemical structure]

wherein R¹ is a C-linked monovalent substituent selected from the group consisting of:

a. substituted alkyl systems comprising from about 9 to about 15 carbon atoms;

b. unsubstituted alkyl systems comprising from about 9 to about 15 carbon atoms;

c. straight alkyl systems comprising from about 9 to about 15 carbon atoms;

d. branched alkyl systems comprising from about 9 to about 15 carbon atoms; and

e. unsaturated alkyl systems comprising from about 9 to about 15 carbon atoms;

wherein R² is selected from the group consisting of:
a. C-linked divalent straight alkyl systems comprising from about 2 to about 3 carbon atoms;
b. C-linked divalent branched alkyl systems comprising from about 2 to about 3 carbon atoms; and
c. combinations thereof;
   wherein M+ is a monovalent counterion selected from a group consisting of sodium, potassium, ammonium, protonated monoethanolamine, protonated diethanolamine, and protonated triethanolamine; and wherein x is on average of from about 0.5 moles to about 3 moles, alternatively from about 1 mole to about 2 moles. In an embodiment, x is on average from about 0.5 moles to about 3 moles of ethylene oxide, alternatively from about 1 mole to about 2 moles of ethylene oxide.

Alkyl sulfates suitable for use herein include materials with the respective formula ROSO₃M, wherein R is an alkyl or an alkenyl of from about 8 carbon atoms to about 24 carbon atoms, and M is a water-soluble cation. Non-limiting examples of M may be selected from the group consisting of ammonium, sodium, potassium, and triethanolamine.

Non-limiting examples of alkyl ether sulfates may be selected from the group consisting of sodium laureth sulfates, ammonium laureth sulfates, potassium laureth sulfates, triethanolamine laureth sulfates, sodium trideceth sulfates, ammonium trideceth sulfates, potassium trideceth sulfates, triethanolamine trideceth sulfates, sodium undeceth sulfates, ammonium undeceth sulfates, potassium undeceth sulfates, triethanolamine undeceth sulfates, and combinations thereof. In an embodiment, the alkyl ether sulfate may be sodium laureth sulfates.

Other suitable anionic surfactants may be described in McCutcheon's Detergents and Emulsifiers, North American Edition (1986), Allured Publishing Corp.; McCutcheon's Functional Materials, North American Edition (1992), Allured Publishing Corp; and U.S. Pat. Nos. 2,486,921, 2,486,922, and 2,396,278.

### Secondary Surfactant

The personal care article may further comprise one or more secondary surfactants selected from the group consisting of amphoteric surfactants, zwitterionic surfactants, and mixtures thereof. The ratio of the one or more anionic surfactants to the one or more secondary surfactants may be from about 15:1 to about 1:2, alternatively from about 10:1 to about 1:1.

Non-limiting examples of amphoteric surfactants may be selected from the group consisting of aliphatic derivatives of secondary and tertiary amines, aliphatic derivatives of heterocyclic secondary and tertiary amines, and mixtures thereof.

Further non-limiting examples of amphoteric surfactants may be selected from the group consisting of sodium cocaminopropionate, sodium cocaminodipropionate, sodium cocoamphoacetate, sodium cocoamphohydroxypropylsulfonate, sodium cocoamphopropionate, sodium cornamphopropionate, sodium lauraminopropionate, sodium lauroamphoacetate, sodium lauroamphohydroxypropylsulfonate, sodium lauroamphopropionate, sodium cornamphopropionate, sodium lauriminodipropionate, ammonium cocaminopropionate, ammonium cocaminodipropionate, ammonium cocoamphoacetate, ammonium cocoamphohydroxypropylsulfonate, ammonium cocoamphopropionate, ammonium cornamphopropionate, ammonium lauraminopropionate, ammonium lauroamphoacetate, ammonium lauroamphohydroxypropylsulfonate, ammonium lauroamphopropionate, ammonium cornamphopropionate, ammonium lauriminodipropionate, triethanonlamine cocaminopropionate, triethanonlamine cocaminodipropionate, triethanonlamine cocoamphoacetate, triethanonlamine cocoamphohydroxypropylsulfonate, triethanonlamine cocoamphopropionate, triethanonlamine cornamphopropionate, triethanonlamine lauraminopropionate, triethanonlamine lauroamphoacetate, triethanonlamine lauroamphohydroxypropylsulfonate, triethanonlamine lauroamphopropionate, triethanonlamine cornamphopropionate, triethanonlamine lauriminodipropionate, cocoamphodipropionic acid, disodium caproamphodiacetate, disodium caproamphoadipropionate, disodium capryloamphodiacetate, disodium capryloamphodipriopionate, disodium cocoamphocarboxyethylhydroxypropylsulfonate, disodium cocoamphodiacetate, disodium cocoamphodipropionate, disodium dicarboxyethylcocopropylenediamine, disodium laureth-5 carboxyamphodiacetate, disodium lauriminodipropionate, disodium lauroamphodiacetate, disodium lauroamphodipropionate, disodium oleoamphodipropionate, disodium PPG-2-isodecethyl-7 carboxyamphodiacetate, lauraminopropionic acid, lauroamphodipropionic acid, lauryl aminopropylglycine, lauryl diethylenediaminoglycine, and mixtures thereof.

Non-limiting examples of zwitterionic surfactants may be selected from the group consisting of derivatives of secondary and tertiary amines, derivatives of heterocyclic secondary and tertiary amines, derivatives of quaternary ammonium, derivatives of quaternary phosphonium, derivatives of tertiary sulfonium, and mixtures thereof.

Non-limiting examples of zwitterionic surfactants may also be selected from the group consisting of betains including alkyl dimethyl betaine and cocodimethyl amidopropyl betaine, C₈-C₁₈ amine oxides, sulfo and hydroxy betaines, and mixtures thereof.

Further non-limiting examples of zwitterionic surfactants may be selected from the group consisting of cocamidoethyl betaine, cocamidopropylamine oxide, cocamidopropyl betaine, cocamidopropyl dimethylaminohydroxypropyl hydrolyzed collagen, cocamidopropyldimonium hydroxypropyl hydrolyzed collagen, cocamidopropyl hydroxysultaine, cocobetaineamido amphopropionate, coco-betaine, coco-hydroxysultaine, oleamidopropyl betaine, coco-sultaine, lauramidopropyl betaine, lauryl betaine, lauryl hydroxysultaine, lauryl sultaine, and mixtures thereof.

### Water-Soluble Polymer

The personal care article may comprise one or more water soluble polymers that may function as a structurant. The personal care article may comprise from about 10% to about 50%, alternatively from about 15% to about 45%, alternatively from about 20% to about 40%, and alternatively from about 25% to about 35% of one or more water soluble polymers, by weight of the personal care article.

The one or more water soluble polymers may have solubility in water, measured at 25° C., of from about 0.1 g/L to about 500 g/L. The one or more water soluble polymers may be of synthetic or natural origin and may be modified by means of a chemical reaction.

In an embodiment, the one or more water soluble polymers may have a weight average molecular weight of from about 40,000 g/mol to about 500,000 g/mol, alternatively from about 50,000 g/mol to about 400,000 g/mol, alternatively from about 60,000 g/mol to about 300,000 g/mol, and alternatively from about 70,000 g/mol to about 200,000 g/mol.

In an embodiment, a 4% by weight solution of one or more water soluble polymers may have a viscosity at 20° C. of from about 4 centipoise to about 80 centipoise, alternatively from about 10 centipoise to about 60 centipoise, and alternatively from about 20 centipoise to about 40 centipoise.

Non-limiting examples of synthetic water soluble polymers may be selected from the group consisting of polyvinyl alcohols, polyvinylpyrrolidones, polyalkylene oxides, polyacrylates, caprolactams, polymethacrylates, polymethylmethacrylates, polyacrylamides, polymethylacrylamides, polydimethylacrylamides, polyethylene glycol monomethacrylates, polyurethanes, polycarboxylic acids, polyvinyl acetates, polyesters, polyamides, polyamines, polyethyleneimines. Further non-limiting examples of synthetic water soluble polymers may be selected from the group consisting of copolymers of anionic, cationic and amphoteric monomers and mixtures thereof, including maleic acrylate based copolymers, maleic methacrylate based copolymers, copolymers of methylvinyl ether and of maleic anhydride, copolymers of vinyl acetate and of crotonic acid, copolymers of vinylpyrrolidone and of vinyl acetate, and copolymers of vinylpyrrolidone and of caprolactam.

Non-limiting examples of natural water soluble polymers may be selected from the group consisting of karaya gum, tragacanth gum, gum arabic, acemannan, konjac mannan, acacia gum, gum ghatti, whey protein isolate, soy protein isolate, guar gum, locust bean gum, quince seed gum, psyllium seed gum, carrageenan, alginates, agar, fruit extracts (pectins), xanthan gum, gellan gum, pullulan, hyaluronic acid, chondroitin sulfate, and dextran, casein, gelatin, keratin, keratin hydrolysates, sulfonic keratins, albumin, collagen, glutelin, glucagons, gluten, zein, shellac, and mixtures thereof.

Non-limiting examples of modified natural water soluble polymers may be selected from the group consisting of (1) cellulose derivatives including hydroxypropylmethylcellulose, hydroxymethylcellulose, hydroxyethylcellulose, methylcellulose, hydroxypropylcellulose, ethylcellulose, carboxymethylcellulose, cellulose acetate phthalate, nitrocellulose, cellulose ethers, cellulose esters; and (2) guar derivatives including hydroxypropyl guar. Suitable hydroxypropylmethylcelluloses may include those available from the Dow Chemical Company (Midland, Mich.).

In an embodiment, the one or more water soluble polymers may be blended with a starch-based material in such an amount as to reduce the overall level of water soluble polymer required. The combined weight percentage of the one or more water soluble polymers and the starch-based material may range from about 10% to about 40%, alternatively from about 12% to about 30%, and alternatively from about 15% to about 25%, by weight of the personal care article. The weight ratio of the one or more water soluble polymers to the starch-based material may range from about 1:10 to about 10:1, alternatively from about 1:8 to about 8:1, alternatively from about 1:7 to about 7:1, and alternatively from about 6:1 to about 1:6.

Non-limiting examples of starch-based materials may be selected from the group consisting of cereals, tubers, roots, legumes, fruits, and combinations thereof. More specifically, non-limiting examples of starch-based materials may be selected from the group consisting of corn, peas, potatoes, bananas, barley, wheat, rice, sago, amaranth, tapioca, arrowroot, canna, sorghum, and combinations thereof. The starch-based materials may also include native starches that are modified using any modification known in the art, including physically modified starches and chemically modified starches.

### Plasticizer

The personal care article may comprise one or more plasticizers. The personal care article may comprise from about 1% to about 30%, alternatively from about 5% to about 25%, and alternatively from about 10% to about 20% of one or more plasticizers, by weight of the personal care article. Non-limiting examples of plasticizers may be selected from the group consisting of polyols, copolyols, polycarboxylic acids, polyesters, dimethicone copolyols, and mixtures thereof.

Non-limiting examples of suitable polyols may be selected from the group consisting of glycerin, diglycerin, propylene glycol, ethylene glycol, butylene glycol, pentylene glycol, cyclohexane dimethanol, hexanediol, polyethylene glycol, sorbitol, manitol, lactitol, monohydric and polyhydric low molecular weight alcohols (e.g., C₂-C₈ alcohols), monosaccharides, disaccharides, oligosaccharides, high fructose corn syrup solids, ascorbic acid, and mixtures thereof.

Non-limiting examples of suitable polycarboxylic acids may be selected from the group consisting of citric acid, maleic acid, succinic acid, polyacrylic acid, polymaleic acid, and mixtures thereof.

Non-limiting examples of suitable polyesters may be selected from the group consisting of glycerol triacetate, acetylated-monoglyceride, diethyl phthalate, triethyl citrate, tributyl citrate, acetyl triethyl citrate, acetyl tributyl citrate, and mixtures thereof.

Non-limiting examples of suitable dimethicone copolyols may be selected from the group consisting of PEG-12 dimethicone, PEG/PPG-18/18 dimethicone, and PPG-12 dimethicone.

Further non-limiting examples of suitable plasticizers may be selected from the group consisting of alkyl phthalates, allyl phthalates, napthalates, lactates (e.g., sodium, ammonium and potassium salts), sorbeth-30, urea, lactic acid, sodium pyrrolidone carboxylic acid (PCA), sodium hyaluronate, hyaluronic acid, soluble collagen, modified protein, monosodium L-glutamate, glyceryl polymethacrylate, polymeric plasticizers, proteins, amino acids, hydrogen starch hydrolysates, low molecular weight esters (e.g., esters of C₂-C₁₀ alcohols and acids), and mixtures thereof. In an additional embodiment, non-limiting examples of suitable plasticizers may be alpha and beta hydroxyl acids selected from the group consisting of glycolic acid, lactic acid, citric acid, maleic acid, salicylic acid, and mixtures thereof. EP 0283165 B1 discloses even more suitable plasticizers, including glycerol derivatives such as propoxylated glycerol.

### Water

The personal care article may comprise from about 0.01% to about 40.0% water. In one embodiment, the personal are article may comprise from about 1.0% to about 25.0% water, alternatively from about 2% to about 20.0% water, alternatively from about 3% to about 15% water by weight of the personal care article. In another embodiment, the personal care article may comprise from about 10% to about 40%, alternatively from about 15% to about 35%, and alternatively from about 20% to about 40% water, by weight of the personal care article.

### Benefit Agent

The personal care article may comprise from about 0.1% to about 15% of a benefit agent. Non-limiting examples of suitable benefit agents may be selected from the group consisting of nonionic surfactants, preservatives, perfumes, coloring agents, cationic polymers, conditioning agents, hair bleaching agents, thickeners, moisturizers, emollients, pharmaceutical actives, vitamins, sunscreens, deodorants, sensates, plant extracts, cosmetic particles, reactive agents, skin lightening agents, skin tanning agents, anti-dandruff agents, exfoliating agents, acids, bases, humectants, enzymes, suspending agents, pH modifiers, hair perming agents, anti-acne agents, anti-microbial agents, exfoliation particles, hair growth agents, insect repellents, chelants, dissolution aids, builders, enzymes, dye transfer inhibiting agents, softening agents, and mixtures thereof.

In an embodiment, the personal care article may be configured as a lubricating strip on a disposable shaving device.

### Conditioning Agents

Non-limiting examples of conditioning agents may be selected from the group consisting of silicones, organic oils, and mixtures thereof. Non-limiting examples of silicones may be selected from the group consisting of silicone oils, high molecular weight polyalkyl or polyaryl siloxanes, aminosilicones, cationic silicones, silicone gums, high refractive silicones, low molecular weight polydimethyl siloxanes, silicone resins, and mixtures thereof. Non-limiting examples of organic oils may be selected from the group consisting of hydrocarbon oils, polyolefins, fatty esters, and mixtures thereof. Additional non-limiting examples of conditioning agents and optional suspending agents for silicone may be found in U.S. Pat. Nos. 5,104,646 and 5,106,609, which are incorporated herein by reference.

The silicone gums and the high molecular weight polyalkyl or polyaryl siloxanes may have a viscosity of from about 100,000 mPa·s to about 30,000,000 mPa·s, alternatively from about 200,000 mPa·s to about 30,000,000 mPa·s. The silicone gums and the high molecular weight polyalkyl or polyaryl siloxanes may have a molecular weight of from about 100,000 g/mol to about 1,000,000 g/mol, and alternatively from about 120,000 g/mol to about 1,000,000 g/mol.

The low molecular weight polydimethyl siloxanes may have a viscosity of from about 1 mPa·s to about 10,000 mPa·s at 25° C., and alternatively from about 5 mPa·s to about 5,000 mPa·s. The low molecular weight polydimethyl siloxanes may have a molecular weight of from about 400 to about 65,000, and alternatively from about 800 to about 50,000.

In an embodiment, the conditioning agent may include one or more aminosilicones. Aminosilicones may be silicones containing at least one primary amine, secondary amine, tertiary amine, or a quaternary ammonium group. In an embodiment the aminosilicones may have less than about 0.5% nitrogen by weight of the aminosilicone, in another embodiment less than about 0.2%, in yet another embodiment less than about 0.1%.

The aminosilicones may have a viscosity of from about 1,000 cs (centistokes) to about 1,000,000 cs, in another embodiment from about 10,000 cs to about 700,000 cs, in yet another embodiment from about 50,000 cs to about 500,000 cs, and in yet another embodiment from about 100,000 cs to about 400,000 cs. This embodiment may also comprise a low viscosity fluid. The viscosity of aminosilicones discussed herein is measured at 25° C.

In another embodiment, the aminosilicones may have a viscosity of from about 1,000 cs to about 100,000 cs, in another embodiment from about 2,000 cs to about 50,000 cs, in another embodiment from about 4,000 cs to about 40,000 cs, and in yet another embodiment from about 6,000 cs to about 30,000 cs.

The personal care composition may comprise from about 0.05% to about 20%, alternatively from about 0.1% to about 10%, and alternatively from about 0.3% to about 5% aminosilicones by weight of the personal care composition.

### Anti-Dandruff Agents

In an embodiment, the personal care article may comprise an anti-dandruff agent which may be an anti-dandruff particulate. Non-limiting examples of suitable anti-dandruff agents may be selected from the group consisting of pyridinethione salts, azoles (e.g. ketoconazole, econazole, and elubiol), selenium sulphide, particulate sulfur, keratolytic agents (e.g. salicylic acid), and mixtures thereof. In an embodiment, the anti-dandruff agent is a pyridinethione salt.

Pyridinethione salt particulates are suitable particulate anti-dandruff agents. In an embodiment, the anti-dandruff agent may be a 1-hydroxy-2-pyridinethione salt in particulate form. The personal care article may comprise from about 0.01% to about 5%, alternatively from about 0.1% to about 3%, and alternatively from about 0.1% to about 2% pyridinethione salt particulates. In an embodiment, the pyridinethione salt particulates may be those formed from heavy metals such as zinc, tin, cadmium, magnesium, aluminium, and zirconium. In any embodiment, the pyridinethione salt may be the zinc salt of 1-hydroxy-2-pyridinethione (known as “zinc pyridinethione” or “ZPT”) optionally in platelet particle form. In an embodiment, the zinc salt of 1-hydroxy-2-pyridinethione in platelet particle form may have an average particle size of less than 20 microns, alternatively less than 5 microns, and alternatively less than 2.5 microns. Salts formed from other cations, such as sodium, may also be suitable anti-dandruff agents. Pyridinethione anti-dandruff agents are described, for example, in U.S. Pat. Nos. 4,323,683; 4,379,753; and 4,470,982.

The personal care article may also comprise an antimicrobial active. Non-limiting examples of suitable anti-microbial actives may be selected from the group consisting of coal tar, sulfur, charcoal, aluminum chloride, gentian violet, octopirox (piroctone olamine), ciclopirox olamine, undecylenic acid and its metal salts, potassium permanganate, selenium sulphide, sodium thiosulfate, propylene glycol, urea preparations, griseofulvin, 8-hydroxyquinoline ciloquinol, thiobendazole, thiocarbamates, haloprogin, polyenes, hydroxypyridone, morpholine, benzylamine, allylamines (such as terbinafine), tea tree oil, clove leaf oil, coriander, palmarosa, berberine, thyme red, cinnamon oil, cinnamic aldehyde, citronellic acid, hinokitol, ichthyol pale, Sensiva SC-50, Elestab HP-100, azelaic acid, lyticase, iodopropynyl butylcarbamate (IPBC), isothiazalinones such as octyl isothiazalinone, azoles, and mixtures thereof. Further non-limiting examples of suitable anti-microbial agents may be selected from the group consisting of itraconazole, ketoconazole, selenium sulphide, coal tar, and mixtures thereof.

In an embodiment, the anti-microbial agent may be an imidazole selected from the group consisting of benzimidazole, benzothiazole, bifonazole, butaconazole nitrate, climbazole, clotrimazole, croconazole, eberconazole, econazole, elubiol, fenticonazole, fluconazole, flutimazole, isoconazole, ketoconazole, lanoconazole, metronidazole, miconazole, neticonazole, omoconazole, oxiconazole nitrate, sertaconazole, sulconazole nitrate, tioconazole, thiazole, and mixtures thereof. In an embodiment, the anti-microbial agent may be a triazole selected from the group consisting of terconazole, itraconazole, and mixtures thereof.

### Cationic Polymers

In an embodiment, the personal care article may comprise a cationic polymer. Cationic polymers useful herein may include those discussed in US 2007/0207109 A1 and US 2008/0206185 A1, such as synthetic copolymers of sufficiently high molecular weight to effectively enhance the deposition of the conditioning active components of the personal care article described herein. Combinations of cationic polymer may also be utilized. The average molecular weight of the synthetic copolymers is generally between about 10,000 and about 10 million, preferably between about 100,000 and about 3 million, still more preferably between about 200,000 and about 2 million.

In a further embodiment, the synthetic copolymers have mass charge densities of from about 0.1 meq/gm to about 6.0 meq/gm, alternatively from about 0.5 meq/gm to about 3.0 meq/gm, at the pH of intended use of the personal care article. The pH may be from about pH 3 to about pH 9, and alternatively from about pH 4 and about pH 8.

In yet another embodiment, the synthetic copolymers have linear charge densities from at least about 2 meq/A to about 500 meq/A, and more preferably from about 20 meq/A to about 200 meq/A, and most preferably from about 25 meq/A to about 100 meq/A.

Cationic polymer may be copolymers or homopolymers. In one embodiment, a homopolymer is utilized in the present composition. In another embodiment, a copolymer is utilized in the present composition. In another embodiment a mixture of a homopolymer and a copolymer is utilized in the present composition. In another embodiment, a homopolymer of a naturally derived nature, such as cellulose or guar polymer discussed herein, is combined with a homopolymer or copolymer of synthetic origin, such as those discussed below.

Homopolymers—Non-crosslinked cationic homopolymers of the following monomers are also useful herein: 3-acrylamidopropyltrimethylammonium chloride (APTAC), diallyldimethylammonium chloride (DADMAC), [(3-methylacrylolyamino)propyl]trimethylammonium chloride (MAPTAC), 3-methyl-1-vinylimidazolium chloride (QVI); [2-(acryloyloxy)ethyl]trimethylammonium chloride and [2-(acryloyloxy)propyl]trimethylammonium chloride.

Copolymers—copolymer may be comprises of two cationic monomer or a nonionic and cationic monomers.

The personal care articles may also comprise cellulose or guar cationic deposition polymers. Generally, such cellulose or guar cationic deposition polymers may be present at a concentration from about 0.05% to about 5%, by weight of the composition. Suitable cellulose or guar cationic deposition polymers have a molecular weight of greater than about 5,000. Additionally, such cellulose or guar deposition polymers have a charge density from about 0.5 meq/g to about 4.0 meq/g at the pH of intended use of the personal care article, which pH will generally range from about pH 3 to about pH 9, preferably between about pH 4 and about pH 8. The pH of the compositions is measured neat.

In one embodiment of the invention, the cationic polymers are derivatives of Hydroxypropyl Guar, examples of which include polymers known via the INCI nomenclature as Guar Hydroxypropyltrimonium Chloride, such as the products sold under the name Catinal CG-100, Catinal CG-200 by the company Toho, Cosmedia Guar C-261N, Cosmedia Guar C-261N, Cosmedia Guar C-261N by the company Cognis, DiaGum P 5070 by the company Freedom Chemical Diamalt, N-Hance Cationic Guar by the company Hercules/Aqualon, Hi-Care 1000, Jaguar C-17, Jaguar C-2000, Jaguar C-13S, Jaguar C-14S, Jaguar Excel by the company Rhodia, Kiprogum CW, Kiprogum NGK by the company Nippon Starch.

### Process of Forming the Dissolvable Foamed Extrudate

The process of forming the dissolvable foamed extrudate as described above may comprise (a) adding one or more water soluble polymers and one or more plasticizers to a twin screw extruder at a first zone temperature of from about 150° C. to about 400° C. to form a premix; (b) cooling the premix to a second zone temperature of from about 100° C. to about 135° C. while mixing one or more anionic surfactants and water with the premix to form a mixture; and (c) incorporating a blowing agent into the extrusion barrel to form a dissolvable foamed extrudate comprising: (i) from about 10% to about 60% of one or more anionic surfactants, wherein the one or more anionic surfactants have a Krafft point of less than about 30° C.; (ii) from about 10% to about 50% of one or more water soluble polymers; (iii) from about 1% to about 30% of one or more plasticizers; and (iv) from about 0.01% to about 30% water; wherein the dissolvable foamed extrudate has a density of from about 0.05 g/cm³ to about 0.95 g/cm³.

The process of forming a dissolvable foamed extrudate may comprise adding one or more water soluble polymers and one or more plasticizers to a twin screw extruder at a first zone temperature to form a premix. The first zone temperature may be from about 150° C. to about 400° C., alternatively from about 155° C. to about 300° C., and alternatively from about 160° C. to about 250° C. In an embodiment, the one or more water soluble polymers and the one or more plasticizers may be compounded together by a separate extrusion process and then added to the twin screw extrusion process as a single ingredient. In another embodiment, the one or more water soluble polymers and the one or more plasticizers may be added to the twin screw extrusion process as separate ingredients.

The process of forming a dissolvable foamed extrudate may comprise cooling the premix to second zone temperature while mixing one or more anionic surfactants in water with the premix to form a mixture. The second zone temperature may be from about 100° C. to about 135° C., alternatively from about 105° C. to about 130° C., alternatively from about 110° C. to about 125° C., and alternatively from about 115° C. to about 120° C. The water may enter the process as a component of one or more raw materials comprising the anionic surfactants, by separate addition to the process, or a combination thereof.

The process of forming a dissolvable foamed extrudate may comprise incorporating a blowing agent into the extrusion barrel to form a dissolvable foamed extrudate. At the end of the extruder, a die is attached to create the flow resistance and pressure build-up within the extrusion barrel to maintain the physical blowing agent in a solubilized form within the molten composite matrix. Otherwise, the blowing agent may phase separate from the molten composite matrix which may deteriorate the quality of the foamed extrudate.

It should be noted that water present within the formula can serve as a blowing agent. However, it has been discovered that the addition of chemical and/or physical blowing agents are required to produce the dissolvable foamed extrudates of the present invention. The physical blowing agent can include ethanol, 2-propanol, acetone, hydrocarbons, butanes, n-pentanes, hexanes, chlorofluorocarbons, compressed gases (nitrogen or carbon dioxide) or combinations thereof.

In one embodiment, the physical blowing agent is a compressed gas such as nitrogen or carbon dioxide. When a compressed gas is used, it can be mixed and dispersed in the molten composition. For example, carbon dioxide can be pumped into a co-rotating twin screw extruder, with mixer zone, and under high pressures. The pressure can vary from about 300 psi to about 6,000 psi, alternatively from about 600 psi to about 5,500 psi, alternatively from about 800 psi to about 5,000 psi, alternatively from about 1000 psi to about 4,500 psi, and alternatively from about 1,200 psi to about 4000 psi. A currently preferred concentration of carbon dioxide is about 1 wt % to about 15 wt. %, alternatively form about 3 wt % to about 12.5 wt %, and alternatively from about 5 wt % to about 10 wt %.

In one embodiment, the blowing agent is a chemical blowing agents including exothermal and exothermal decomposition compounds. Exothermal blowing agents release more energy during decomposition than needed to initiate decomposition. Once decomposition has started it continues spontaneously and even goes on for some time when the energy supply has been stopped. Parts foamed with exothermal blowing agents must be cooled intensely to avoid post expansion. In one embodiment, the chemical blowing agent is selected from an exothermal decomposition compound selected from hydrazides and azo compounds, such as azodicarbonamide and modified Azodicarbonamide, p,p′-oxybis (benzenesulfonyl hydrazide), and p-toluene sulfonyl hydrazide.

In one embodiment, the chemical blowing agent is selected from endothermal blowing agents which require energy to decompose. For this reason, gas release quickly stops after termination of heat supply. In one embodiment, the endothermal blowing agent is selected from bicarbonate and citric acid. These are common food additives which are safe to handle and ingest. The amount of chemical blowing agents may be from about 0.5 wt % to about 10 wt. %,

Nucleating agents may also be incorporated within the present invention in order to produce a uniform, fine-cellular foam structure. The quantity of nucleating agent utilised in the course of the process depends on the process conditions and the desired morphology for the extruded, partly-finished product. Preferably, the quantity of nucleating agent with respect to the starting composition lies in the range between 0.05 and 10% by weight, preferably between 0.5 and 7% and more preferably between 1 and 5%.

In one embodiment, the nucleating agent may be selected from an inorganic compound such as talc (magnesium silicate), calcium carbonate, sulphates such as sodium and barium, titanium dioxide, zeolites and silicates etc. The inorganic particles may be possibly surface treated with adhesion promotors such as silanes, titanates, etc.). In one embodiment, the nucleating agent may be selected from zeolites and silicates including wollastonites, montmorillonites, and hydrotalcytes.

In one embodiment, the nucleating agent may be selected from organic fillers and fibers such as wood powder, cellulose powder, grape residue, bran, maize husks, other natural fibres in concentrations of from about 0.5% to about 20%, alternatively from about 1.0% to about 15%, alternatively from about 2.0% to about 10.0%.

In an embodiment, the nucleating agent may be micro fibrillated cellulose. Microfibrillated cellulose is a material composed of micro- and nano-sized cellulose fibrils with a high aspect ratio. In an embodiment, the microfibrillaed cellulose may have an average fiber length of from about 0.4 mm to about 0.5 mm and with a fiber thickness range varying from about 0.01 micrometers to several micrometers.

In an embodiment, a twin screw extrusion process, either alone or in combination with other forming operations, may be used depending on the desired type of the final product. Two different types of extruders may be employed consisting of a twin screw extruder and single screw extruder. The twin screw extruder may be a conical twin screw extruder. In an embodiment, the process may utilize a tandem extrusion set up which consists of two or more of extruders connected in a series or in parallel. The tandem extrusion set up may use a twin-screw extruder to improve mixing between the water soluble polymer and the rest of ingredients, followed by a single-screw extruder for effective extrusion foaming and cooling.

In an embodiment, a further third zone temperature may be employed involving further cooling of the mixture prior to exiting the extruder or via a secondary tandem extruder. This can be important to mitigate collapse of the foam upon exiting the extruder. The third zone temperature range may be from about 50° C. to about 110° C., alternatively from about 60° C. to about 100° C., and alternatively from about 70° C. to about 90° C.

The foamed extrudate can also be shaped via die geometry, cutting or molding processes. In one embodiment, the die may be cylindrical die, an annular die, or a slot die. In one embodiment, the extrudate is then cut into defined lengths including tubules, bars, films, pellets, spheres, hollow tubules, hollow bars, etc. In another embodiment, two or more different foamed extrudates may be combined into a shape via co-extruding, co-mixing or layering. In another embodiment, the said two or more extrudates may comprise differing compositions.

### EXAMPLES

### Extrusion Compounding Process

The manufacturing of the present invention utilizes polymer extrusion technology. For this extrusion process, two different types of extruders are employed and they are twin-screw extruder and single-screw extruder. In addition, this invention also utilizes a tandem extrusion set up, which consists of two or more of these extruders and the extruders are connected either in series or parallel to satisfy specific needs. In this invention, the purpose of the tandem extrusion is to improve mixing between polymer and the rest of ingredients with using a twin-screw extruder and effective cooling via a single-screw extruder during the extrusion process. The manufacturing of this invention can be carried out all at once or divided into two or more folds. The first extrusion compounding of polyvinyl alcohol with glycerin is to plasticize polyvinyl alcohol and decrease its processing temperature. The objective of second extrusion phase is compounding, which is to effectively mix polyvinyl alcohol/glycerin matrix with the rest of solution type ingredients. Third extrusion phase is to introduce foaming via utilizing physical, chemical, or both types of blowing agents to produce final foam structure. Although the examples in this invention are manufactured with two or three stage manufacturing strategy, one stage manufacturing can be carried out with a tandem setup, which utilizes one or more twin-screw extruders and a single-screw extruder, when the order of compounding is maintained.

### 1^{st} Extrusion Compounding of Polyvinyl Alcohol (PVOH)/Glycerin

Polyvinyl alcohol is the only polymer component of final composite and provides structural integrity for the extruded foam product. In order to extrudate polyvinyl alcohol, it requires a plasticizer otherwise it easily experiences thermal degradation because the melting temperature of polyvinyl alcohol is very close to or higher than its thermal degradation temperature. For this purpose, liquid-form glycerin is utilized as a plasticizer of PVOH in this present invention. However, other plasticizer(s) can also be employed to help suppress the processing temperature of PVOH below its thermal degradation temperature. It is critically important to inject the glycerin into the barrel as early as possible in this compounding process. Since the content of glycerin with respect to PVOH amount determines the possible processing temperature range and manufacturability of PVOH/glycerin composite, the appropriate weight ratio between the glycerin and the PVOH is studied and determined based on the results from Differential Scanning calorimeter (DSC). When the glycerin content is 50 per hundred resin (phr) or equivalently 33.3 wt %, the melting temperature of PVOH/glycerin is 147° C. Although the melting temperature can be further decreased with increased glycerin content, the post processing-ability of high glycerin content composites is not suitable for this multi-stage manufacturing strategy. In the present invention, therefore, the specific weigh ratio between the PVOH and glycerin is 66.7 wt % to 33.3 wt %, respectively.

Once the weight ratio of PVOH and glycerin is determined, the extrusion compounding is carried out. The compounding of PVOH/glycerin is accomplished by using a single-screw extruder, a twin-screw extruder, or a tandem extrusion set up. For this invention, the use of a twin-screw extruder is most preferred because it not only can provide significant amount of mechanical mixing energy via shear and extension of materials but also can provide the flexibility to optimize the configuration of extrusion screw based on the requirements of different formulations. For this purpose, both co-rotation and counter-rotation types of twin-screw extruders can be implemented. In the present invention, however, a co-rotation twin-screw extruder is equipped with multiple injection ports along its barrel in order to directly inject liquid-form glycerin into the barrel.

In the present invention, a twin-screw extruder from Leistritz (with 27 mm screw diameter, 40:1 L/D ratio, 10 independent temperature control barrel pieces) is used. The twin-screw extrusion system needs to be heated to desired temperatures prior to the actual compounding process. The temperatures are shown in Table 1 Temperature profile of twin-screw extruder for compounding of Celvol 523 (PVOH) and glycerin Table 1 below.

TABLE 1
Temperature profile of twin-screw extruder for
compounding of Celvol 523 (PVOH) and glycerin

| Barrel zone | Temperature [° C.] |
|---|---|
| Zone 1 | 180 |
| Zone 2 | 200 |
| Zone 3 | 180 |
| Zone 4 | 180 |
| Zone 5 | 160 |
| Zone 6 | 160 |
| Zone 7 | 150 |
| Zone 8 | 150 |
| Zone 9 | 140 |
| Die | 140 |

When the temperatures are reached, it is important to wait another ten minutes before the operation to ensure the heat is transferred from the barrel to the screw. The PVOH granulates are fed into the barrel via using a weight-loss gravimetric feeder from Brabender Technologies at a certain feeding ratio whereas the glycerin is injected into the barrel via using a couple of 260D high pressure syringe pump from Teledyne Isco at a specific volumetric injection rate, which should be adjusted by the feeding rate of PVOH. Although other types of high pressure liquid pump can be used to inject liquid-form glycerin, the 260D high pressure syringe pump is preferred because it can provide the injection pressure up to 6500 psi and very accurate volumetric flow rate. It is also possible to use different processing temperatures with the given weight ratio of PVOH and glycerin. However, this set of temperatures is preferred because the excessively high torque is required if the processing temperatures are lower than the values in Table 1. If the processing temperatures are higher than the values in Table 1, on the other hand, it is highly possible to cause thermal degradation of PVOH during the extrusion compounding process.

Since both of the PVOH and the glycerin are water-soluble materials, the composite must be cooled with the compressed air, in which has the temperature range of 10 to 20° C., as it extrudes out from the TSE. There are other means to cool this water-soluble composite, but the compressed air is the most cost effective method. The final stage of compounding is pelletizing of cooled PVOH/glycerin composite, and this step is carried out via using a pellletizer, which is BT25 from Scheer Bay Co.

### Preparation of Overall Surfactant Solution Mixture

The overall surfactant solution mixture is prepared by mixing the solution ingredients together either manually or automatically. For the mixing stage, all the ingredients are put in a suitable clean container or vessel based on their predetermined weight ratio and then mixed sufficiently until homogeneous mixture is obtained. The surfactant solution mixture in the present invention is comprised of 70% active alcohol ethoxy sulfate (SLE1S) and other ingredients such as perfume and color dye powder. The mixing is carried out in the atmospheric environment at room temperature. Regardless of mixing method, the mixing process itself should be carried out slowly and gently. Once all the mixing is finished, it is important to seal the mixed surfactant solution and rest it for a couple of hours before using for the compounding process.

### 2^{nd} Extrusion Compounding of PVOH/Glycerin and the Surfactant Solution Mixture

The purpose of this second extrusion compounding process is to effectively mix PVOH/glycerin matrix with the surfactant solution mixture. Similar to the first extrusion compounding process, the second extrusion compounding can be carried out with a single-screw extruder, a twin-screw extruder, or a tandem extrusion setup. In this present invention, a tandem extrusion setup, which consists of a twin-screw extruder and a single-screw extruder, is most preferred because this system configuration can provide not only the sufficient mixing from the twin-screw extruder but also effective cooling from the single-screw extruder. Furthermore, the twin-screw has a number of injection ports, where the additional water and the surfactant solution mix are injected into the barrel, and the injection locations are also very critical to the mixing quality of final dissolving solid composite.

In this present invention, the twin-screw extruder with 27 mm screw diameter and 40:1 L/D ratio from Leistritz is utilized whereas the single-screw extruder from David Standard with 0.75″ of screw diameter and 30 L/D ratio is employed. These two extruders are connected via using a flange pipe, which has independent temperature control unit, and the set temperature values for this tandem extrusion setup is described in Table 2 below. Since it is very critical to maintain the processing temperature below 120° C. after injecting the surfactant solution, the temperature profile in Table 2 is most preferred for this present invention. If the set temperatures are higher, then it triggers the thermal degradation of 70% active alcohol ethoxy sulfate. If the temperatures are lower, it does not melt PVOH/glycerin matrix, which results poor mixing behavior. However, there can be some degree of variation depends on the formulation.

TABLE 2
Temperature profile of tandem extrusion line for
compounding of surfactant solution composite

| Barrel zone | Temperature [° C.] |
|---|---|
| TSE Zone 1 | 140 |
| TSE Zone 2 | 160 |
| TSE Zone 3 | 120 |
| TSE Zone 4 | 120 |
| TSE Zone 5 | 120 |
| TSE Zone 6 | 110 |
| TSE Zone 7 | 100 |
| TSE Zone 8 | 100 |
| TSE Zone 9 | 90 |
| TSE Adaptor | 90 |
| Flange Pipe | 100 |
| SSE Barrel 1 | 90 |
| SSE Barrel 2 | 80 |
| SSE Barrel 3 | 70 |
| SSE Adaptor | 65 |

For this second extrusion compounding process, unlike the first extrusion compounding process, it requires two injection locations, one for the surfactant solution mixture and another for the additional water. In this present invention, the surfactant solution mixture is injected into either Zone 3 or Zone 6. For the additional water, it is injected into Zone 6 if the surfactant solution mixture is injected into Zone 3 or vice versa. The main reason for these injection locations being away from each other is to provide enough residence time for the first injected material to react with PVOH/glycerin matrix before getting mixed with the second injected material. In the case of surfactant solution mixture, it is also possible to inject each ingredient at different locations separately rather than as the surfactant solution mixture at one specific location. However, the injecting as the surfactant solution mixture provides more convenience to the manufacturing process in this present invention. Both the additional water and the surfactant mixture are injected into the twin-screw extruder barrel via using three or more high pressure syringe pumps, 260D pumps from Teledyne Isco Inc. In addition, the PVOH/glycerin pellets are fed into the barrel via using a weight-loss gravimetric feeder from Brabender Technologies at a certain feeding ratio.

### Use of Additional Water

For the second extrusion compounding process, the existence of additional water and its content play very critical role in determining the quality of final dissolving solid composite. It serves as another plasticizer for PVOH/glycerin matrix as well as mixing enhancer of the final composite. Although some ingredients such as alcohol ethoxy sulfate and cocamidopropyl betaine have significant amount of water in their solution states already, its participation in the plasticization and mixing is very minimal. Therefore, use of separate additional water is absolutely necessary to produce good quality of final dissolving solid composite.

The content of additional water also affects the hardness of final dissolving solid composite, so its content should be determined carefully according to its weight ratios with the rest of ingredients. If the additional water content is excessively high, then the final composite does not have any structural integrity to maintain the final shape. On the other hand, excessively low content of additional water deteriorates the mixing quality of final composite.

### 3^{rd} Extrusion Phase for Foaming

For the third extrusion process, a single-screw extruder, a twin-screw extruder, or a tandem extrusion set up is employed to accommodate foaming process. For this invention, the tandem extrusion line is preferred because this system can provide both efficient mixing from the twin-screw extruder and enhanced cooling within the single-screw extruder. The extruded composite, which consists of polyvinyl alcohol, glycerin, surfactant solution, additional water, and other ingredients if applicable, is being dried and fed directly into the first extruder of tandem system. In the first extruder, the composite is re-melted and mixed to achieve uniform mixing prior to the injection of blowing agent in the second extruder. A gear pump is attached between the end of first extruder and the beginning of second extruder. The purpose of gear pump is to convey the molten composite flow from the first extruder to the second extruder. Furthermore, the employment of gear pump enables this flow transfer to be very consistent despite the pressure difference between two extruders. In the second extruder, a physical blowing agent is injected directly into the barrel and mixed to accomplish the uniform mixture between the composite ingredients and the blowing agent. At the end of the second extruder, a die is attached to create the flow resistance and build up in the barrel and the die. A certain level of pressure is necessary to maintain the blowing agent to be solubilized in the molten composite matrix. Otherwise, a phase separation between the blowing agent and the molten composite flow is occurred and this phase separation deteriorates the quality of final foam structure.

### Injection of Physical Blowing Agent

The injection of physical blowing agent is carried out via using high pressure high precision syringe pump(s) from Teledyne Isco Inc. In this article, the described examples employ super-critical fluid status of carbon dioxide, CO₂, only as a physical blowing agent. However, this invention covers other types of physical blowing agents and the mixture of two or more physical blowing agents including N₂, n-Butane, n-Pentane, iso-Butane, and so on.

### Physical Characteristics

### Materials

This present invention utilizes five different materials, and they are polyvinyl alcohol, glycerin, alcohol ethoxy sulfate, additional water, and perfume if applicable. For polyvinyl alcohol, a commercial grade of Celvol 523 from Sekisui Chemical Co. Ltd. is utilized for this present invention. Superol Glycerin USP from Procter and Gamble Company is utilized as a liquid-form glycerin for this present invention. For alcohol ethoxy sulfate, STEOL CS-170 from Stepan Company is employed. In the case of additional water, regular tab water is employed. For the physical blowing agent, CO₂ from Linde Gas Inc. is utilized.

### Foaming Properties

This article utilizes two physical properties to evaluate the manufactured foam structure. The first property is a volume expansion ratio or simply an expansion ratio. The volume expansion ratio is defined as below:

$$Volume Expansion Ratio ( VER ) = \frac{{ρ}_{solid polymer}}{{ρ}_{foam}} \qquad Equation 1$$

where ρ_{foam} is the final density of foam structure, which is measured based on ASTM D792-00. The second property is a cell density. The cell density is defined as following:

$$Cell density = {( \frac{\# of cells}{Measured Area} )}^{\frac{3}{2}} \cdot VER \qquad Equation 2$$

In order to observe the cellular morphology of extruded foam sample, furthermore, a scanning electron microscope (SEM) is employed in this article. The scanning electron microscope is JSM-6060 from JEOL Inc.

### EXAMPLES

### Example 1

### Extrusion Foaming Via Lab-Scale Twin-Screw and Single-Screw Tandem System

For this example, PVOH/glycerin pellets are prepared via the first extrusion compounding process as described in the previous section. For the second extrusion compounding process, the surfactant solution and additional water are injected separately into the twin-screw extruder to accomplish the uniform mixture with PVOH/glycerin matrix. As for the surfactant solution mixture, it consists of alcohol ethoxy sulfate only. The contents of the materials are provided in Table 3. When calculating overall water content for all the examples described in this invention, it is assumed that alcohol ethoxy sulfate includes 30% water.

TABLE 3
Material ingredients of Example 1

| Component | wt % |
|---|---|
| Polyvinyl alcohol | 29.59 |
| Glycerin | 14.79 |
| Alcohol ethoxy sulfate solution (70% activity) | 37.87 |
| Additional Water | 17.75 |
| Overall Water | 29.11 |
| Polymer:Active Surfactant | 52.7:47.3 |
| Active alcohol ethoxy sulfate | 26.51 |

For the second extrusion stage of this example, the tandem extrusion set up is employed as described previously. The temperature profile of tandem extrusion for this example is shown in Table 4 below. It is very similar to the values in Table 2 except the single-screw barrel temperatures are slightly lower in order to build up sufficient pressure before the die, which is necessary for foaming. The solution mix is injected in TSE Zone 3 via using a set of 260D high pressure syringe pumps from Teledyne Isco Inc. In addition, the additional water is injected in TSE Zone 5 via using a set of the syringe pumps.

TABLE 4
Temperature profile of tandem extrusion line for
compounding of surfactant solution composite

| Barrel zone | Temperature [° C.] |
|---|---|
| TSE Zone 1 | 140 |
| TSE Zone 2 | 160 |
| TSE Zone 3 | 120 |
| TSE Zone 4 | 120 |
| TSE Zone 5 | 120 |
| TSE Zone 6 | 110 |
| TSE Zone 7 | 110 |
| TSE Zone 8 | 100 |
| TSE Zone 9 | 90 |
| TSE Adaptor | 90 |
| Flange Pipe | 90 |
| SSE Barrel 1 | 75 |
| SSE Barrel 2 | 65 |
| SSE Barrel 3 | 65 |
| SSE Adaptor | 60 |
| Filamentary Die | 60 |

The composite has a form of cylindrical strand when it is extruded out from the die. The strands are collected and dried in the atmosphere at the room temperature. During this drying period, the overall water content in the extruded composite from the second extrusion phase reduces from 29.11 wt % to approximately 12 wt % and the similar range of water content is maintained during the rest of drying period.

The dried composite is fed into the lab-scale twin-screw in this example and this lab-scale twin-screw extruder has the screw diameter of 30 mm with its 10 L/D ratio. As described in the previous section, the gear pump is attached at the end of this lab-scale twin-screw extruder to convey the composite melt flow to the single-screw extruder. This single-screw extruder has 0.75 inch of screw diameter and 20 of L/D ratio. The temperature profile and the other processing conditions of third extrusion stage of this example are described in Table 5. The filamentary die is implemented in this example and it has the diameter of 1 mm and 22.5 for the L/D ratio. The die temperature is varied from 110 to 120° C. as described in Table 5 to change the die pressure and study the effects of this pressure variation on the foaming behavior of the composite.

TABLE 5
Temperature profile and processing conditions
for extrusion foaming process

| Barrel Zone | Temperature [° C.] |
|---|---|
| TSE | 125 |
| Gear pump | 125 |
| SSE Barrel 1 | 130 |
| SSE Barrel 2 | 120 |
| SSE Barrel 3 | 110 |
| SSE Barrel 4 | 110 |
| Die | 110, 115, 120 |
| Processing Condition | Value |
| TSE RPM | 67.6 |
| Gear pump RPM | 30 |
| SSE RPM | 37 |

The physical blowing agent of CO₂ is injected in the second single-screw extruder as described in the previous section. The content of CO₂ is 2.0 wt % in this example.

Due to the variation of die temperature, the die pressure is varied. Because of this rapid pressure drop that the molten composite/blowing agent flow experiences as it exits from the die, foaming occurs and the extrudate becomes expanded. Therefore, the expansion ratio, i.e., VER, values are measured 3 hours after the experiments. The maximum expansion ratio of 5.5 is achieved when the die temperature is 110° C. The maximum cell density of 10⁷ cells/cm³ is obtained with 110° C. of die temperature.

### Example 2

### Extrusion Foaming Via 27 mm Twin-Screw Tandem Extrusion Line

In this example, the twin-screw extruder, which has a screw diameter of 27 mm and 40 L/D ratio, from Leistritz is employed instead of the lab-scale twin-screw extruder from Example 1. The identical single-screw extruder from Example 1 is attached to the twin-screw extruder via using a flange pipe. Furthermore, this example does not employ the gear pump between two extruders.

The extruded and dried composite strand, which has the identical material ingredients as Table 3 in Example 1, is fed into the twin-screw extruder and its temperature profile is exhibited in Table 6. This temperature profile is determined to maximize the melting of fed composite without the thermal degradation of alcohol ethoxy sulfate.

TABLE 6
Temperature profile of 27 mm twin-screw extruder of Example 2

| Barrel zone | Temperature [° C.] |
|---|---|
| TSE Zone 1 | 70 |
| TSE Zone 2 | 110 |
| TSE Zone 3 | 130 |
| TSE Zone 4 | 125 |
| TSE Zone 5 | 120 |
| TSE Zone 6 | 120 |
| TSE Zone 7 | 120 |
| TSE Zone 8 | 120 |
| TSE Zone 9 | 115 |
| TSE Adaptor | 95 |
| Flange Pipe | 115 |

This example utilizes super-critical CO₂ as a physical blowing agent and it is directly injected into TSE Zone 5 via using the high pressure syringe pumps as described in the previous section. Regarding the amount of physical blowing agent, 3.0 and 4.0 wt % of CO₂ are injected in this example.

The temperatures of the single-screw extruder are varied to provide the cooling for the molten composite/blowing agent flow because larger degrees of cooling yield greater amount of flow resistance at the die by increasing the melt viscosity, which can be converted to higher die pressure values. The identical filamentary die from Example 1 is employed in this example as well. The varied temperature profiles of the single-screw extruder for both 3.0 and 4.0 wt % CO₂ are displayed in Table 7.

TABLE 7
Temperature profile of single-screw extruder of Example 2

| | CO₂ Content | | | | |
|---|---|---|---|---|---|
| | 3.0 wt % | | | 4.0 wt % | |
| | Condi- | Condi- | Condi- | Condi- | Condi- |
| Barrel Zone | tion 1 | tion 2 | tion 3 | tion 4 | tion 5 |
| SSE 1 [° C.] | 120 | 120 | 120 | 115 | 115 |
| SSE 2 [° C.] | 120 | 120 | 120 | 115 | 115 |
| SSE 3 [° C.] | 120 | 120 | 120 | 115 | 115 |
| Adaptor [° C.] | 120 | 120 | 120 | 115 | 115 |
| Die [° C.] | 110 | 105 | 101 | 105 | 100 |

As the temperatures are reduced, the die pressure values are increased as shown in Table 8 along with the expansion ratio and the cell density measurements. Although the die pressures increased significantly by the reduction of barrel and die temperatures, the final foam characteristics are not affected since almost identical foam structures are obtained from all five experimental conditions of this example.

TABLE 8
Properties of extruded foam samples in Example 2

| Experimental | Die Pressure | | Cell Density |
|---|---|---|---|
| Condition No. | [psi] | Expansion Ratio | [cells/cm³] |
| Condition 1 | 860 | 2.8 | 1.5E+06 |
| Condition 2 | 960 | 2.5 | 1.3E+06 |
| Condition 3 | 1220 | 2.5 | 1.6E+06 |
| Condition 4 | 1230 | 2.4 | 2.0E+06 |
| Condition 5 | 1450 | 2.4 | 2.0E+06 |

### Example 3

### Foam Extrusion Via Using Chemical Blowing Agent

The earlier described examples, Example 1 and Example 2, utilized the physical blowing agent, which is super-critical CO₂. This example, however, employs a chemical blowing agent to initiate foaming. The chemical blowing agent is sodium bicarbonate, NaHCO₃, and it is also known as a baking soda. This chemical blowing agent releases CO₂ gas to its surrounding via its thermal decomposition process. The thermal decomposition process takes place when the melt temperature is higher than the thermal decomposition temperature of chemical blowing agent. In the case of sodium bicarbonate, the thermal decomposition temperature is 70° C.

Since there is no need for the injection of physical blowing agent in this example, the third extrusion phase is eliminated. Since the chemical blowing agent is in fine powder shape, it is added into the pre-mixed surfactant solution and injected directly into the twin-screw extruder barrel. The contents of material ingredients are shown in Table 9.

TABLE 9
Material ingredients of Example 3

| Component | wt % |
|---|---|
| Polyvinyl alcohol | 29.76 |
| Glycerin | 14.88 |
| Alcohol ethoxy sulfate solution (70% activity) | 38.10 |
| Additional Water | 11.90 |
| Perfume | 2.08 |
| Chemical Blowing Agent | 3.27 |
| Overall Water | 23.33 |
| Polymer:Active Surfactant | 52.7:47.3 |
| Active alcohol ethoxy sulfate | 26.67 |

The temperature profile of tandem extrusion line is displayed in Table 10. The surfactant solution/chemical blowing agent pre-mix is injected in TSE Zone 3 whereas the additional water is injected in TSE Zone 6.

TABLE 10
Temperature profile of tandem extrusion line of Example 3

| Barrel zone | Temperature [° C.] |
|---|---|
| TSE Zone 1 | 140 |
| TSE Zone 2 | 160 |
| TSE Zone 3 | 120 |
| TSE Zone 4 | 120 |
| TSE Zone 5 | 110 |
| TSE Zone 6 | 110 |
| TSE Zone 7 | 100 |
| TSE Zone 8 | 90 |
| TSE Zone 9 | 90 |
| TSE Adaptor | 90 |
| Flange Pipe | 90 |
| SSE Barrel 1 | 75 |
| SSE Barrel 2 | 65 |
| SSE Barrel 3 | 65 |
| SSE Adaptor | 65 |
| Sheet Die | 30 |

This example employs a sheet die instead of a filamentary die from the previous examples.

Since the cells obtained from this example are significantly larger than the ones from the previous examples, an optical microscope is utilized to evaluate the cellular morphology of foam samples. The average cell diameter of the foam sample is 0.25 mm.

In this example, the expansion ratio and the cell density values are not discussed because the measured values are very low and not comparable to the ones from the previous examples.

### Example 4

### Foam Extrusion Via Using a Slit Die

As mentioned in the previous section, this example utilizes three separate stages of extrusion process, which are the compounding of PVOH/glycerin, the compounding of PVOH/glycerin and the surfactant solution mixture, and the extrusion foaming. In terms of blowing agent, this example utilizes CO₂ as its physical blowing agent.

In the second stage of extrusion process, PVOH/glycerin pellets are fed into the 27 mm twin-screw extruder of tandem system and mixed with the surfactant solution. The surfactant solution is mixed prior to the second stage extrusion process and directly injected into the barrel of twin-screw extruder. The temperature profile of the second stage extrusion process is described in Table 11. The injection of surfactant solution pre-mix is occurred in TSE Zone 3 while the additional water is injected into TSE Zone 4. The material ingredients of this second stage extrusion process are exhibited in Table 12.

TABLE 11
Temperature profile of tandem system of Example 4

| Barrel zone | Temperature [° C.] |
|---|---|
| TSE Zone 1 | 140 |
| TSE Zone 2 | 160 |
| TSE Zone 3 | 120 |
| TSE Zone 4 | 120 |
| TSE Zone 5 | 120 |
| TSE Zone 6 | 110 |
| TSE Zone 7 | 110 |
| TSE Zone 8 | 110 |
| TSE Zone 9 | 95 |
| TSE Adaptor | 100 |
| Flange Pipe | 95 |
| SSE Barrel 1 | 85 |
| SSE Barrel 2 | 75 |
| SSE Barrel 3 | 70 |

TABLE 12
Material ingredients of Example 4

| Component | wt % |
|---|---|
| Polyvinyl alcohol | 28.99 |
| Glycerin | 14.49 |
| Alcohol ethoxy sulfate solution (70% activity) | 37.10 |
| Additional Water | 17.39 |
| Perfume | 2.03 |
| Overall Water | 28.52 |
| Polymer:Active Surfactant | 52.7:47.3 |
| Active alcohol ethoxy sulfate | 25.97 |

After the second extrusion process, the extruded composite strands are dried until the overall water content becomes approximately 15 to 17 wt %. The dried composite strands are fed into the twin-screw extruder for the third extrusion process. The third phase extrusion process is the identical tandem extrusion line as the second phase extrusion process. The temperature profile of the third extrusion process is described in Table 13. 0.75 wt % of CO₂ is injected into TSE Zone 4 via using the high pressure syringe pump as aforementioned.

TABLE 13
Temperature profile of tandem system for
the third extrusion stage of Example 4

| Barrel zone | Temperature [° C.] |
|---|---|
| TSE Zone 1 | 70 |
| TSE Zone 2 | 100 |
| TSE Zone 3 | 115 |
| TSE Zone 4 | 120 |
| TSE Zone 5 | 120 |
| TSE Zone 6 | 110 |
| TSE Zone 7 | 110 |
| TSE Zone 8 | 110 |
| TSE Zone 9 | 95 |
| TSE Adaptor | 100 |
| Flange Pipe | 90 |
| SSE Barrel 1 | 85 |
| SSE Barrel 2 | 80 |
| SSE Barrel 3 | 70 |
| Slit Die | 65 |

A slit die is employed in this example and is attached at the end of the single-screw extruder. Its opening dimension is 0.8 mm (thickness) by 30 mm (width). The die land length is 35 mm.

The die pressure is maintained around 160 psi during the experiment. The final foam structure has the cell density of 1.8E+05 whereas the average expansion ratio is equal to 1.307. The low expansion ratio is mainly due to fairly low die pressure and the small CO₂ content.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for forming a personal care article comprising:
a. producing an extrudate within a twin screw extruder; and
b. extrusion foaming the extrudate into the personal care article, the personal care article comprising:
i. from about 10% to about 60% of one or more anionic surfactants, wherein the one or more anionic surfactants have a Krafft point of less than about 30° C., by weight of the personal care article;
ii. from about 10% to about 50% of one or more water soluble polymers, by weight of the personal care article;
iii. from about 1% to about 30% of one or more plasticizers, by weight of the personal care article; and
iv. from about 0.01% to about 40% water, by weight of the personal care article;
wherein the personal care article has a density of from about 0.05 g/cm³ to about 0.95 g/cm³.

2. The process of claim 1, wherein the personal care article has a density of from about 0.10 g/cm³ to about 0.90 g/cm³.

3. The process of claim 1, wherein the personal care article has a density of from about 0.15 g/cm³ to about 0.85 g/cm³.

4. The process of claim 1, wherein the water is from about 10% to about 40%.

5. The process of claim 1, wherein the one or more anionic surfactants have a Krafft point of less than about 25° C.

6. The process of claim 1, wherein the one or more anionic surfactants comprises one or more alkyl ether sulfates according to the following structure: [chemical structure]
wherein R¹ is a C-linked monovalent substituent selected from the group consisting of:
a. substituted alkyl systems comprising from about 9 to about 15 carbon atoms;
b. unsubstituted alkyl systems comprising from about 9 to about 15 carbon atoms;
c. straight alkyl systems comprising from about 9 to about 15 carbon atoms;
d. branched alkyl systems comprising from about 9 to about 15 carbon atoms; and
e. unsaturated alkyl systems comprising from about 9 to about 15 carbon atoms;
wherein R² is selected from the group consisting of:
a. C-linked divalent straight alkyl systems comprising from about 2 to about 3 carbon atoms;
b. C-linked divalent branched alkyl systems comprising from about 2 to about 3 carbon atoms; and
c. combinations thereof;
wherein M+ is a monovalent counterion selected from a group consisting of sodium, potassium, ammonium, protonated monoethanolamine, protonated diethanolamine, and protonated triethanolamine; and
wherein x is an average of from about 0.5 to about 3.

7. The process of claim 6, wherein x is on average from about 0.5 to about 3.0 moles of ethylene oxide.

8. The process of claim 6, wherein the alkyl ether sulfate is sodium laureth sulfate.

9. The process of claim 1, wherein the personal care article comprises from about 15% to about 50% of one or more anionic surfactants.

10. The process of claim 1, wherein the one or more water soluble polymers is selected from the group consisting of polyvinyl alcohol, polyvinylpyrrolidone, polyalkylene oxide, starch, starch derivatives, pullulan, gelatin, hydroxypropylmethylcellulose, methycellulose, carboxymethycellulose, and mixtures thereof.

11. The process of claim 1, wherein the one or more plasticizers is selected from the group consisting of glycerin, propylene glycol, polyols, copolyols, polycarboxylic acids, polyesters, dimethicone copolyols, and mixtures thereof.

12. The process of claim 1, wherein the personal care article further comprises a secondary surfactant selected from the group consisting of amphoteric surfactants, zwitterionic surfactants, and mixtures thereof; and wherein the ratio of the one or more anionic surfactants to the secondary surfactant is from about 10:1 to about 1:2.

13. The process of claim 1, wherein the personal care article further comprises from about 0.1% to about 15% of one or more benefit agents.

14. The process of claim 13, wherein the one or more benefit agents is selected from the group consisting of anti-dandruff agents, conditioning agents, moisturizers, and combinations thereof.

15. The process of claim 13, wherein the conditioning agent is selected from the group consisting of silicones, aminosilicones, quaternized silicones, and combinations thereof.

16. The process of claim 1, wherein the personal care article is shaped by a molding process.

17. A process of forming a personal care article comprising:
a. adding one or more water soluble polymers and one or more plasticizers to a twin screw extruder at from about 150° C. to about 400° C. to form a premix;
b. cooling the premix to from about 100° C. to about 135° C. while mixing one or more anionic surfactants and water with the premix to form a mixture; and
c. incorporating a blowing agent into the twin screw extruder to form a personal care article comprising:
i. from about 10% to about 60% of one or more anionic surfactants, wherein the one or more anionic surfactants have a Krafft point of less than about 30° C., by weight of the personal care article;
ii. from about 10% to about 50% of one or more water soluble polymers, by weight of the personal care article;
iii. from about 1% to about 30% of one or more plasticizers, by weight of the personal care article; and
iv. from about 0.01% to about 40% water, by weight of the personal care article;
wherein the personal care article has a density of from about 0.05 g/cm³ to about 0.95 g/cm³.

18. The process of claim 17, wherein the blowing agent is a physical blowing agent selected from the group consisting of ethanol, 2-propanol, acetone, hydrocarbons, butanes, n-pentanes, hexanes, chlorofluorocarbons, compressed gases (nitrogen or carbon dioxide), and combinations thereof.

19. The process of claim 17, wherein the blowing agent is compressed carbon dioxide gas at from about 1% to about 15% by weight of the mixture.

20. The process of claim 17, wherein a nucleating agent is also incorporated within the extruder at a level of from about 0.05% to about 10% by weight of the mixture.
